(19) United States
(12) Patent Application Publication
(10) Pub. No.: US 2022/0198326 A1
(43) Pub. Date: Jun. 23, 2022

(54) SPECTRAL DATA PROCESSING FOR CHEMICAL ANALYSIS

(71) Applicant: Virtual Control Limited, Sheung Wan (HK)

(72) Inventor: Tamas Ross Taldon King, Pui O (HK)

(21) Appl. No.: 17/232,812

(22) Filed: Apr. 16, 2021

(30) Foreign Application Priority Data
Dec. 17, 2020 (HK) 32020022285.1

(51) Int. Cl. G06N 20/00; G01N 30/72; G01N 30/86

(52) U.S. Cl. CPC G06N 20/00; G01N 30/7206; G01N 30/7233; G01N 30/8675; G01N 30/8637; G01N 30/8644; G01N 30/8631

(57) ABSTRACT

A method for operating a spectral data processing system. The method includes receiving a user input associated with processing of a spectral data of a chemical sample at least partly using a machine learning processing model. The machine learning processing model is arranged in a machine learning controller of the spectral data processing system. The method also includes training the machine learning processing model based on the received user input.

### TECHNICAL FIELD

The invention relates to the processing of spectral data for chemical analysis. The processing is based, at least in part, on machine learning based method(s).

### BACKGROUND

Chemical analysis relates to the analysis of chemical composition and structure of substances in a chemical sample, and it may involve qualitative analysis and/or quantitative analysis using chemical analysis equipment.

Gas chromatography-mass spectrometer is a known chemical analysis equipment. It combines a gas chromatographer and a mass spectrometer, and is used to identify different substances in a chemical sample obtained for different applications (drug testing, food safety related testing, environmental-related testing, etc.).

Currently available gas chromatography-mass spectrometer is usually connected with an analyzer, e.g., a computing system, arranged to analyze spectral signal generated by the gas chromatography-mass spectrometer. The analyzer may run a software package or application program, such as the existing AMDIS-NIST software, which enables the user to analyze, view, adjust, or edit the spectral data for performing qualitative and/or quantitative analysis on the sample. In this process the quality of the output, the qualitative and/or quantitative analysis result, depends heavily on user's expertise and experience in interpreting or otherwise handling the data. Also, as the experiments are performed independently, a customary practice or prejudice is to treat the associated data processing independently.

### SUMMARY OF THE INVENTION

In a first aspect of the invention, there is provided a method for operating a spectral data processing system. The method includes: receiving a user input associated with processing of a spectral data of a chemical sample at least partly using a machine learning processing model and storing the user input for training the machine learning processing model based on the received user input. The machine learning processing model is arranged in a machine learning controller of the spectral data processing system. The processing of the spectral data can be entirely based on the machine learning processing model, or alternatively, partly based on the machine learning processing model and partly based on one or more of: other machine learning processing models or non-machine-learning processing. The machine learning controller may be formed by one or more processors, optionally with one or more memory or storage. The method is a computer-implemented method. The machine learning processing model may be pre-trained sufficiently to be suited for a specific task (e.g., the model can provide certain accuracy for that specific task). Or, the machine learning processing model may be an untrained or an insufficiently-trained model for baseline back testing. Non-machine-learning processing may include various signal processing such as filtering, segmenting, thresholding, averaging, smoothing, padding, transforming, scaling, etc. of spectral data.

In one embodiment the method further includes training the machine learning processing model based on the received user input. In one example, the received user input is used directly to train the machine learning processing model. In another example, data associated with the received user input is used to train the machine learning processing model.

In one embodiment the method further includes, prior to receiving the user input: processing the spectral data at least partly using the machine learning processing model to provide a processing result. The processing may include performing one or more or all of the following using the machine learning processing model: spectral signal segmentation; spectral peak detection; spectral peak deconvolution; and chemical component related information determination. The chemical component related information determination may be performed based on the spectral signal segmentation, spectral peak detection, and/or the spectral peak deconvolution. The chemical component related information determination may determine only one, only some, or all chemical components in the chemical sample. In one example, all four exemplary operations are performed based on the machine learning processing model. In one example, only one or only some of these exemplary operations are performed based on the machine learning processing model. The chemical component related information determination may include one or more of: chemical component class identification; chemical component type identification; chemical component identification; and chemical component concentration determination.

In one embodiment the method further includes, prior to receiving the user input: providing a processing result of the processing of the spectral data. In one example, the processing result may be provided to an output device, such as a display, for presentation to a user. In one embodiment providing the processing result includes providing at least one of: a graphical representation of at least part of the spectral data; and information associated with at least one (one or some or all) chemical component contained in the chemical sample. The graphical representation may be in the form of a plot, a spectrum, a table, a heat-map, or the like. The information associated with the chemical component may include identity of the least one chemical component and/or concentration of each of the at least one chemical component.

In one embodiment the method further includes, prior to the processing: selecting the machine learning processing model from a plurality of machine learning processing models. The plurality of machine learning processing models may all be arranged in the machine learning controller. Each of the respective one of the plurality of machine learning processing models may be associated with a respective type or class of chemical sample, a respective chemical analysis system, a respective geographical location, a respective user (company, individuals, etc.), and the selection may be based on these characteristics.

In one embodiment the user input represents a positive feedback on the processing result. In one example, the training of the machine learning processing model based on the received user input (representing a positive feedback) includes training the machine learning processing model based on the spectral data and the processing result. In one example, data associated with the received user input (representing a positive feedback) is retained, weighted, or otherwise used in subsequent training of the machine learning processing model. In this manner, the machine learning processing model can be reinforced by learning what is correct as indicated by the user.

In one embodiment the user input represents a negative feedback on the processing result. In one example, the user input is associated with an adjustment on the spectral data and/or an adjustment on the processing result. For example, the user input may include one or more of the following: an adjusted peak start time; an adjusted peak end time; an adjusted peak baseline; an adjusted background subtraction; an adjusted retention time; an adjusted identity of a chemical component in the chemical sample; and an adjusted concentration of a chemical component in the chemical sample. In one example in which the user input is associated with an adjustment on the spectral data, the method further includes processing the adjusted spectral data at least partly using the machine learning processing model to determine an updated processing result. The training of the machine learning processing model based on the received user input (representing a negative feedback) may include training the machine learning processing model based on the adjusted spectral data and the updated processing result; training the machine learning processing model based on the spectral data (e.g., if not adjusted) and the adjusted identity or concentration. In this manner, the machine learning processing model can be improved by learning what was initially incorrect and subsequently adjusted to be correct by the user.

In one embodiment the machine learning processing model includes an artificial neural network, such as a deep neural network. Other machine learning based models, recurrent models or non-recurrent models, can be used. These may include, e.g., recurrent neural network, long-short term memory model, Markov process, reinforcement learning, gated recurrent unit model, deep neural network, convolutional neural network (e.g., Unet), support vector machines, principle component analysis, logistic regression, decision trees/forest, ensemble method (combining model), regression (Bayesian/polynomial/regression), stochastic gradient descent, linear discriminant analysis, nearest neighbor classification or regression, naive Bayes, just to name a few.

In one embodiment the method further includes, prior to the processing: determining a format of the spectral data, and if it is determined that the format of the spectral data is a proprietary format, converting the format of the spectral data from a proprietary format to an open format. Determining a format of the spectral data may include determining whether the format of the spectral data is recognizable. Acceptable or recognizable proprietary formats may be predetermined.

In one embodiment the method further includes: receiving one or more further user inputs, each associated with a respective processing of a respective spectral data of a respective chemical sample using the machine learning processing model; and storing the one or more received further user inputs for training the machine learning processing model based on the one or more received further user inputs.

In one embodiment the method further includes training the machine learning processing model based on the one or more received further user inputs. The training may be performed periodically, after a predetermined number of user inputs have been received, upon user request, continuously/recurrently, etc.

In one embodiment the chemical sample may include phthalate, or the machine learning processing model may be specifically adapted for processing spectral data associated with phthalate.

In one embodiment the spectral data is data of a chromatogram or a mass spectrum.

In one embodiment the spectral data processing system is associated with a chemical analysis system. The spectral data processing system may be locally connected with the chemical analysis system, e.g., via a wired communication connection. Alternatively the spectral data processing system may be remotely connected the chemical analysis system, e.g., via a wireless communication network.

In one embodiment the chemical analysis system includes a gas chromatograph or a liquid chromatograph, and the spectral data includes data of a chromatogram of a chemical sample. In another example the chemical analysis system includes a mass spectrometer, and the spectral data includes data of a mass spectrum of a chemical sample. The mass spectrometer may be a gas chromatography-mass spectrometer or a liquid chromatography-mass spectrometer.

In a second aspect of the invention there is provided a spectral data processing system including one or more processors arranged to: receive a user input associated with processing of a spectral data of a chemical sample at least partly using a machine learning processing model; and train the machine learning processing model based on the received user input. The spectral data processing system may also include one or more memory or storage to store the user input and/or the machine learning processing model. In one example, the spectral data processing system includes a machine learning controller, and the one or more processors and the one or more memory may be part of the machine learning controller. In another example, the machine learning controller may not include the one or more processors, and instead, may include one or more other processors operably coupled with the one or more processors. In yet another example, the one or more processors include multiple processors, at least one of which is arranged to perform training and at least one of which is arranged to perform processor of spectral data.

In one embodiment the one or more processors are further arranged to: process the spectral data at least partly using the machine learning processing model to provide a processing result.

In one embodiment the one or more processors are further arranged to perform one or more or all of the following using the machine learning processing model: spectral signal segmentation; spectral peak detection; spectral peak deconvolution; and chemical component related information determination. The chemical component related information determination may include one or more of: chemical component class identification; chemical component type identification; chemical component identification; and chemical component concentration determination.

In one embodiment the spectral data processing system also includes an output device arranged to provide a processing result of the processing of the spectral data. The output device may include a display arranged to display the processing result. In one example, the processing result may be in the form of at least one of: a graphical representation (e.g., plot/spectrum/table/heat-map) of at least part of the spectral data; and information associated with at least one chemical component contained in the chemical sample. Information associated with the chemical component includes: identity of the least one chemical component and/or concentration of each of the at least one chemical component.

In one embodiment the one or more processors are further arranged to: select or receive selection of the machine learning processing model from a plurality of machine learning processing models. The plurality of machine learning processing models may all be arranged in the machine learning controller. Each of the respective one of the plurality of machine learning processing models may be associated with a respective type or class of chemical sample, a respective chemical analysis system, a respective geographical location, a respective user (company, individuals, etc.), and the selection may be based on these characteristics.

In one embodiment the user input represents a positive feedback on the processing result. In one example upon receiving the user input that represents a positive feedback, the one or more processors are arranged to train the machine learning processing model based on the received user input e.g., by, at least, training the machine learning processing model based on the spectral data and the processing result.

In one embodiment the user input represents a negative feedback on the processing result. In one example, the user input is associated with an adjustment on the spectral data and/or an adjustment on the processing result. For example, the user input may include one or more of the following: an adjusted peak start time; an adjusted peak end time; an adjusted peak baseline; an adjusted background subtraction; an adjusted retention time; an adjusted identity of a chemical component in the chemical sample; and an adjusted concentration of a chemical component in the chemical sample. In one example in which the user input is associated with an adjustment on the spectral data, the one or more processors are arranged to process the adjusted spectral data at least partly using the machine learning processing model to determine an updated processing result. The one or more processors arranged to train the machine learning processing model based on the received user input (representing a negative feedback) may train the machine learning processing model based on the adjusted spectral data and the updated processing result; train the machine learning processing model based on the spectral data (e.g., if not adjusted) and the adjusted identity or concentration. In this manner, the machine learning processing model can be improved by learning what was initially incorrect and subsequently adjusted to be correct by the user.

In one embodiment the machine learning processing model includes an artificial neural network, such as a deep neural network. Other machine learning based models, recurrent models or non-recurrent models, can be used. These may include, e.g., recurrent neural network, long-short term memory model, Markov process, reinforcement learning, gated recurrent unit model, deep neural network, convolutional neural network (e.g., Unet), support vector machines, principle component analysis, logistic regression, decision trees/forest, ensemble method (combining model), regression (Bayesian/polynomial/regression), stochastic gradient descent, linear discriminant analysis, nearest neighbor classification or regression, naive Bayes, just to name a few.

In one embodiment the one or more processors are arranged to: determine a format of the spectral data; and convert the format of the spectral data from a proprietary format to an open format if it is determined that the format of the spectral data is a proprietary format. The one or more processors may be arranged to determine whether the format of the spectral data is recognizable in order to determine the format of the spectral data. Acceptable or recognizable proprietary formats may be predetermined.

In one embodiment, the one or more processors are arranged to: receive one or more further user inputs, each associated with a respective processing of a respective spectral data of a respective chemical sample using the machine learning processing model; and train the machine learning processing model based on the one or more received further user inputs. The one or more further inputs may be stored in one or more memory or storage of the spectral data processing system.

In one embodiment, the one or more processors may perform training periodically, after a predetermined number of user inputs have been received, upon user request, continuously/recurrently, etc.

In one embodiment the chemical sample may include phthalate, or the machine learning processing model may be specifically adapted for processing spectral data associated with phthalate.

In one embodiment the spectral data is data of a chromatogram or a mass spectrum.

In one embodiment the spectral data processing system is associated with a chemical analysis system. The spectral data processing system may be locally connected with the chemical analysis system, e.g., via a wired communication connection.

Alternatively the spectral data processing system may be remotely connected the chemical analysis system, e.g., via a wireless communication network.

In one embodiment the chemical analysis system includes a gas chromatograph or a liquid chromatograph, and the spectral data includes data of a chromatogram of a chemical sample. In another example the chemical analysis system includes a mass spectrometer, and the spectral data includes data of a mass spectrum of a chemical sample. The mass spectrometer may be a gas chromatography-mass spectrometer or a liquid chromatography-mass spectrometer.

In a third aspect of the invention there is provided a system including: one or more chemical analysis systems; and a spectral data processing system of the first aspect operably connected with the one or more chemical analysis systems. The one or more chemical analysis systems include: one or more gas chromatographs; one or more liquid chromatographs; one or more gas chromatography-mass spectrometers; and/or one or more a liquid chromatography-mass spectrometers. The system may also include one or more database operably connected with the spectral data processing system, e.g., via communication network or link, locally or remotely. The one or more database may include a database storing reference spectral data that can be used by the spectral data processing system to process spectral data. The one or more database may include another database storing user input, training data, spectral data, machine learning processing models, etc.

In a fourth aspect of the invention, there is provided one or more machine learning processing models in the first or second aspect.

In a fifth aspect of the invention, there is provided a computer program product containing the one or more machine learning processing models of the fourth aspect.

In a sixth aspect of the invention, there is provided a computer system, with hardware and/or software components, providing various means to perform the method of the first aspect.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF THE DRAWINGS

Embodiments of the invention will be described, by way of example, with reference to the accompanying drawings, in which:

FIG. 1 is a schematic diagram of a system including a spectral data processing system in one embodiment of the invention;

FIG. 2 is a schematic diagram of a system including a spectral data processing system in another embodiment of the invention;

FIG. 3 is a schematic diagram of a system including multiple spectral data processing systems in one embodiment of the invention;

FIG. 4 is a schematic diagram of a system including multiple spectral data processing systems in another embodiment of the invention;

FIG. 5A is a schematic diagram of a system including a spectral data processing system in another embodiment of the invention;

FIG. 5B is a schematic diagram of a system including a spectral data processing system in another embodiment of the invention;

FIG. 6 is a functional block diagram of a spectral data processing system in one embodiment of the invention;

FIG. 7 is a functional block diagram of a machine learning controller in a spectral data processing system in one embodiment of the invention;

FIG. 8 is a schematic diagram of a machine learning controller arranged to perform chemical analysis in one embodiment of the invention;

FIG. 9 is a flowchart of a method for operating a spectral data processing system in one embodiment of the invention;

FIG. 10 is a flowchart of a method for processing spectral data in one embodiment of the invention;

FIG. 11 is a flowchart of a method for processing spectral data in one embodiment of the invention;

FIG. 12A is a block diagram of a machine learning controller in one embodiment of the invention;

FIG. 12B is a block diagram of a machine learning controller in another embodiment of the invention; and

FIG. 13 is a block diagram of an information handling device in one embodiment of the invention.

### DETAILED DESCRIPTION

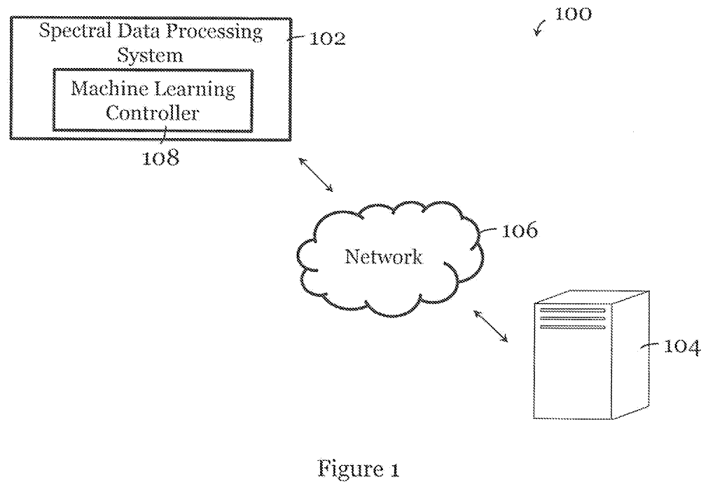

FIG. 1 shows a system 100 in one embodiment of the invention. The system 100 includes a spectral data processing system 102 operably connected with a server 104 via a communication network 106. The spectral data processing system 102 is implemented by hardware and/or software components, and is arranged to interact with a user to process spectral data of chemical samples for facilitating analyzing of the chemical samples. The spectral data may be provided to the spectral data processing system 102 locally, e.g., via a connected chemical analysis system, or remotely, from a remotely connected chemical analysis system or other information handling system (smart phone, laptop, tablet computer, desktop computer, etc.). The spectral data processing system 102 includes, among other components, a machine learning controller 108. The machine learning controller 108 is arranged to process the spectral data using machine learning processing model(s). The machine learning processing model(s) can be trained, by the spectral data processing system 102 or by another system, based on user input associated with the processing by the controller 108, as will be described in more detail below. By training the machine learning processing model(s) based on user input, the machine learning processing model(s) may become more accurate or effective in analyzing spectral data of chemical samples. In one example the spectral data processing system 102 can obtain data from the server 104 for facilitating the processing of the spectral data. For example, the server 104 may store various standard sample spectrums of known chemical substances or components. The spectral data processing system 102 may retrieve these data for identification of chemical substances or components in a chemical sample based on its spectral data. The communication network 106 may provide a wired (cable, USB, etc.) or wireless (Bluetooth®, Wi-Fi, near field communication, cellular communication, ZigBee, RFID) communication link between the spectral data processing system 102 and the server 104.

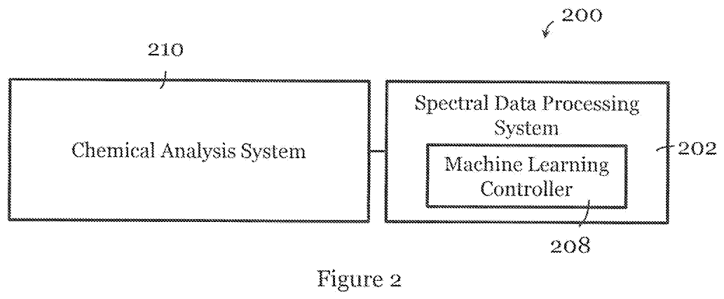

FIG. 2 shows a system 200 in one embodiment of the invention. The system 200 includes a spectral data processing system 202 with a machine learning controller 208 connected locally with a chemical analysis system 210. In this example, the chemical analysis system 210 is a gas chromatography-mass spectrometer, and in other embodiments, it may be a different type of chemical analysis system that can generate spectral data associated with a chemical sample. The spectral data processing system 202 is similar or generally the same as the spectral data processing system 102 of FIG. 1, except that the spectral data processing system 202 is connected locally with the chemical analysis system 210. A user of the chemical analysis system 210 can readily access the spectral data processing system 102 for processing spectral data generated by the chemical analysis system 210, as the two systems 202, 210 are located near (e.g., in the same premise/location) or adjacent each other. The machine learning controller 208 serves similar or generally the same function as the machine learning controller 108, which is to process spectral data of the chemical sample using machine learning processing model(s), which can be trained based on user input associated with the processing by the controller 208, as will be described in more detail below. The spectral data processing system 202 and the chemical analysis system 210 may be connected via a wired (cable, USB, etc.) or wireless (Bluetooth®, Wi-Fi, near field communication, cellular communication, ZigBee, RFID) communication link.

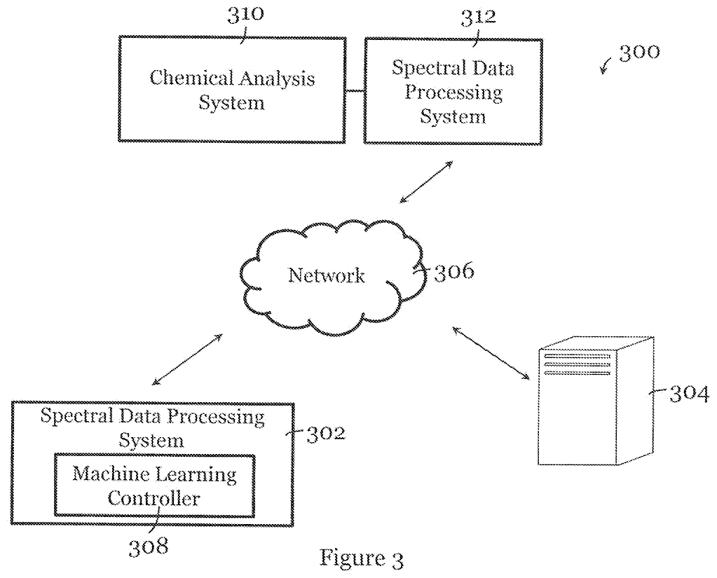

FIG. 3 shows a system 300 in one embodiment of the invention. The system 300 includes a spectral data processing system 302 with a machine learning controller 308, a server 304, and a chemical analysis system assembly operably connected with each other via a communication network 306. The operation and/or arrangement of the spectral data processing system 302, the machine learning controller 308, the network 306, and the server 304 may be similar or generally the same as the spectral data processing system 102, the machine learning controller 108, the network 106, and the server 104 in FIG. 1. For simplicity, these are not repeated here. The chemical analysis system assembly includes a chemical analysis system 310 and a spectral data processing system 312 arranged adjacent and operably connected with each other. In this example, the chemical analysis system 310 is a gas chromatography-mass spectrometer, and in other embodiments, it may be a different type of chemical analysis system that can generate spectral data associated with a chemical sample. The spectral data processing system 312 of the chemical analysis system 310 does not include a machine learning controller, hence itself does not include any machine learning based processing ability, but can access the machine learning controller 308 on the remote spectral data processing system 302 via the network 306, to process data generated by the chemical analysis system 310 using the machine learning controller 308. The spectral data processing system 312 of the chemical analysis system 310 may act as a dummy, i.e., simply provide an interface to access the remote spectral data processing system 302. Additionally or alternatively, the spectral data processing system 312 of the chemical analysis system 310 may be able to process spectral data generated by the system 310 without using any machine learning based processing methods, and may access the database in server 304 to obtain data useful for processing the spectral data, with or without using machine learning based processing methods. In this embodiment, the user of the spectral data processing system 312 can provide user input (e.g., feedback) on the processing of the spectral data (processing with or without using the machine learning processing model), e.g., whether/how the processing is correct, accurate, or accurate enough; change(s) to the data and/or result required to improve the correctness or accuracy of the processing or otherwise to obtain a more useful result than provided by the processing of the data by the system 312. The user input, and in particular the associated data and information provided by the user in response to the processing by the system (with or without using machine learning), may be used as training data (e.g., input-output pairs in supervised learning) for training machine leaning model(s) of the machine learning controller 308 in the remote system 302.

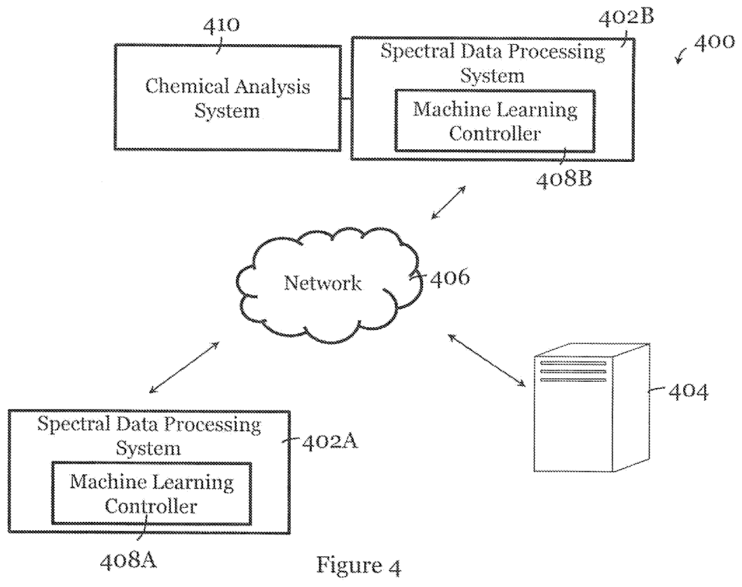

FIG. 4 shows a system 400 in one embodiment of the invention. The system 400 is similar to the system 300 in FIG. 3, except that the spectral data processing system 402B of the chemical analysis system 410 also includes a machine learning controller 408B. For simplicity, the similarities of the embodiments of FIGS. 3 and 4 are not repeated here. The two machine learning controllers 408A, 408B can both provide machine learning processing capability for processing spectral data. In one example, the machine learning controllers 408A, 408B may include the same machine learning processing model(s) or at least some common (shared by both) machine learning processing model(s). In another example, the machine learning controllers 408A, 408B may each include respective machine learning processing model(s) each adapted for processing a respective type or class of spectral data. The spectral data processing system 402B of the chemical analysis system 410 can selectively use its machine learning controller 408B to process spectral data, if suitable in view of the properties (e.g., class, type, size, format, etc.) of spectral data, and may access the machine learning controller 408A on the remote spectral data processing system 402A for processing spectral data, as appropriate. In one example, the machine learning controller 408A on the remote spectral data processing system 402A may be a master controller, and the machine learning controller 408B of the chemical analysis system 410 may be a slave controller controlled by the master controller. The two spectral data processing systems 402A, 402B, and their associated machine learning controllers 408A, 408B, can communicate data and information, including user input and associated data/information as described above, via the network 406. The machine learning processing model(s) of the machine learning controllers 408A, 408B can be trained using training data, including training data associated with the user input (e.g., feedback) on the processing of the spectral data (the processing with or without using the machine learning processing model).

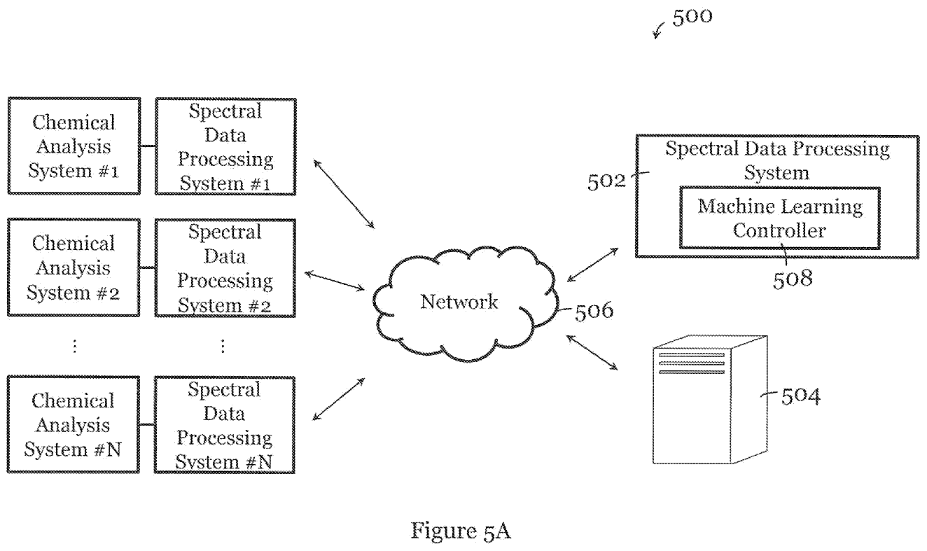

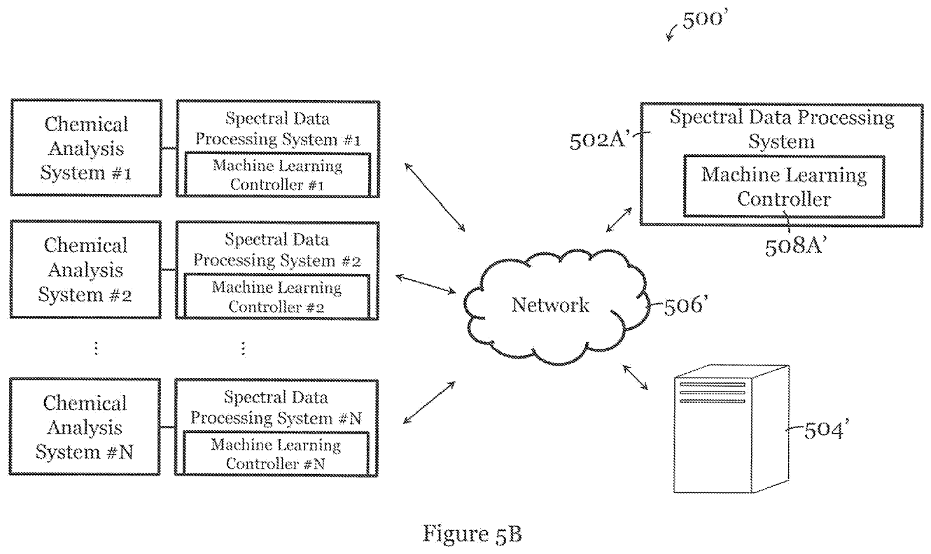

FIG. 5A shows a system 500 in one embodiment of the invention. The system 500 is similar to the system 300 in FIG. 3 (like features not repeatedly described), except that in FIG. 5A multiple chemical analysis system assemblies are operably connected with the spectral data processing system 502 with machine learning controller 508 and the server 504 via the network 506. Each chemical analysis system assemblies include a chemical analysis system and a local spectral data processing system, which may be similar or generally the same as the chemical analysis system assembly of FIG. 3. In this embodiment, the remote spectral data processing system 502 can be accessed by different spectral data processing systems for processing spectral data generated by the different chemical analysis systems. The machine learning controller 508 may maintain or operate one or more machine learning based processing model(s) for processing spectra data received from these different spectral data processing systems. In one example where there includes multiple machine learning processing models, the machine learning controller 508 use the most appreciate machine learning processing model, based on user selection, based on determined data properties, based on specific user accounts, based on specific spectral data processing systems accessing the controller 508, etc., to process the spectral data. In this embodiment, user of the spectral data processing systems of the chemical analysis systems can each provide user input (e.g., feedback) on the respective processing of the spectral data (processing with or without using the machine learning processing model), e.g., whether/how the processing is correct, accurate, or accurate enough; change(s) to the data and/or result required to improve the correctness or accuracy of the processing or otherwise to obtain a more useful result than provided by the processing of the data by the system. All of the user input, and in particular the associated data and information provided by the user in response to the processing by the system (with or without using machine learning), as collected from all of these chemical analysis system assemblies, may be used as training data (e.g., input-output pairs in supervised learning) for training one or more machine leaning processing model(s) of the machine learning controller 508 in the remote system 502.

FIG. 5B shows a system 500′ in one embodiment of the invention. The system 500′ is essentially a modification of the system 400 of FIG. 4, with, instead of one, multiple chemical analysis system assemblies each include respective chemical analysis system and local spectral data processing system having a machine learning controller. The interaction of each chemical analysis system assembly with the spectral data processing system 502A′ and machine learning controller 508A′ can be similar or generally the same as the interaction of the chemical analysis system assembly with the spectral data processing system 402A and machine learning controller 408A in FIG. 4. In one example, the machine learning controller 508A′ is a master controller that controls or operates the machine learning controllers of the chemical analysis system assemblies. In this embodiment, each machine learning controller of the chemical analysis system assembly may include separate public and private collection of machine learning processing models: one or more unique (unshared) local machine learning processing model(s) and/or one or more shared machine learning processing model(s) shared by two or more systems. The machine learning controller 508A′ on the remote spectral data processing system 502A′ may include one or more global machine learning processing model(s), e.g., learned from user input and associated data multiple (e.g., selected ones) or all of the chemical analysis system assemblies. In one example, the machine learning controller 508A′ may include a collection of machine learning processing model(s) each suited for a respective task (e.g., class, type of chemical, etc.) that can be accessed as needed by the chemical analysis system assemblies. In one embodiment, all machine learning controllers may be able to learn and improve the machine learning processing model(s) based on only user input (locally, from one or more chemical analysis system assemblies, globally, etc.).

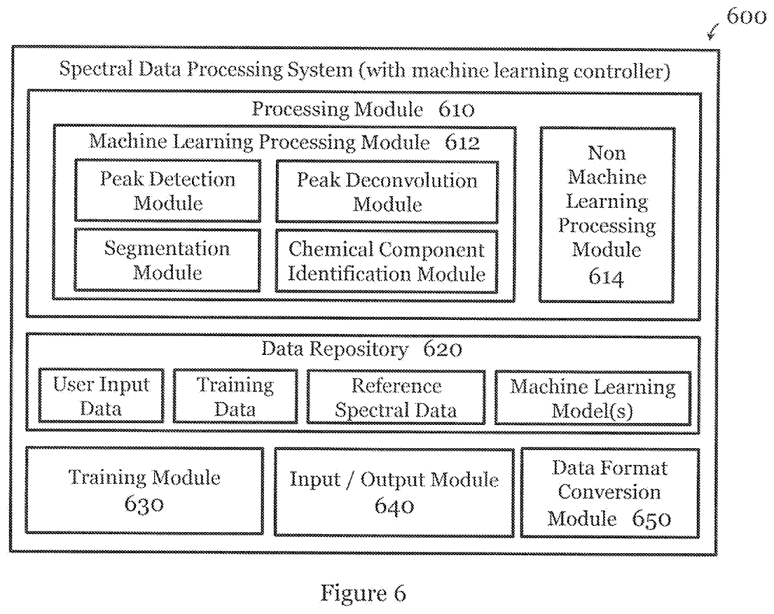

FIG. 6 shows the functional block diagram of a spectral data processing system (with machine learning controller) 600 in one embodiment of the invention. The blocks illustrated in FIG. 6 are functional blocks which do not delimit structures and can be implemented by hardware and/or software components/combinations. The spectral data processing system (with machine learning controller) 600 can corresponding to any of the spectral data processing system (with machine learning controller) in FIGS. 1 to 5B

The system 600 includes a processing module 610 for processing spectral data, a data repository for storing, temporarily or permanently, various data useful for or generated by the processing module 610, a training module 630 arranged to train the machine learning model(s), an input/output module 640 arranged to transmit and/or receive information or data, and a data format conversion module 650 for converting a format of the spectral data to be processed by the processing module 610. It should be appreciated that one or more of the functional blocks can be omitted, and one or more additional functional blocks can be added, to provide different embodiments of the spectral data processing system.

In this embodiment, the processing module 610 has a machine learning processing model 612 and non-machine learning processing module 614. The machine learning processing module 612 is arranged to process spectral data using machine learning based processing models, such as that stored in the data repository 620, or one received from an external device via the input/output module 640. The machine learning processing module 612 includes various sub-modules, including: a peak detection module arranged to perform peak detection of the spectral data, a peak deconvolution module arranged to de-convolve the peak of the spectral data, a segmentation module arranged to segment to spectral data, and a chemical component(s) identification module arranged to identify information associated with or concentration of the chemical component(s). The non-machine learning processing module 614 is arranged to process spectral data without using machine learning based methods. For example, the non-machine learning processing module 614 may be used to perform various signal processing such as filtering, segmenting, thresholding, averaging, smoothing, padding, transforming, scaling, etc. of the spectral data. Each processing of a set of spectral data of a chemical sample can involve the use of only machine learning processing, only non-machine learning processing, or both.

The data repository 620 stores user input data, training data used for training the machine learning processing model(s), reference spectral data for processing spectral data, and machine learning model(s). The user input data relates to user input on the processing performed by the processing module 610. For example, if the processing module 610 produces a result that is satisfactory (considered correct, accurate, or accurate enough) by the user, the original spectral data and the resulting processing output can be used (e.g., given more weight) as input-output pairs in the training of the machine learning processing model; if the processing module 610 produces a result that is not satisfactory (considered incorrect, inaccurate, or not accurate enough) by the user, the user can make changes to original spectral data and/or the resulting processing output, and optionally re-run the processing, to produce updated spectral data/processing output. These user updated spectral data/processing output may then be used as input-output pairs in the training of the machine learning processing model. The training data may include data that is used to train the model(s). In one embodiment the data may be classified based on class of chemical sample, application, etc., for use in the training of different machine learning models. The reference spectral data is used as part of the processing for the system 600 to determine the most likely candidates of chemical components in the sample (as indicated by the spectral data). One or more machine learning processing models may be stored in the data repository 620, and the models may be updated as needed, e.g., by training or retrieving from external device operably connected with the system 600.

The training model 630 is arranged to select or use the appropriate training data, optionally with a suitable weighting, for training of the machine learning processing model(s). The input/output module 640 can be used to communicate with external device or may be used to provide a user interface that enables the user to interact with the system 600, e.g., to receive spectral data for processing, to provide a user interface to receive user input and optionally enable the user to edit the data in the repository, to present processing output to the user, etc.

The data format conversion module 650 is arranged to convert the format of the spectral data to a format that is usable by the system 600. In one example, the data format conversion module 650 is arranged to recognize various spectral data format and is arranged to convert the format into a default preferred format of the system 600. In one example, the data format conversion module 650 is arranged to determine a format of the spectral data received, and upon determining that the format is a proprietary format, convert the proprietary format into a default (e.g., open) format. By converting the proprietary format, which may be different for different types of chemical analysis systems or the same type of chemical analysis systems manufactured by different manufacturers, prior to processing the spectral data, the irregulars caused, e.g., by the above-mentioned differences, may be reduced if not eliminated, which improves the performance of the machine learning processing models when the spectral data (with or without user adjustment) are subsequently used to train the machine learning processing models.

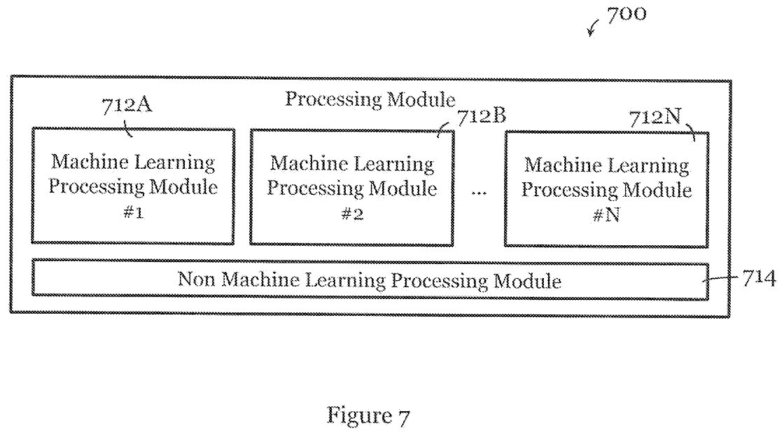

FIG. 7 shows an alternative processing module 700 for the system 600 of FIG. 6. The processing module 700 is similar to the processing module 610, with a non-machine-learning processing module 715, and multiple machine learning processing modules 712A-712N each arranged for a specific spectral data processing task. The machine learning processing modules 712A-712N may or may not each include sub-module like machine learning processing module. Each of the machine learning processing modules may be associated with processing of spectral data of: a respective type or class of chemical sample, a respective chemical analysis system, a respective geographical location, a respective user (company, individuals, etc.).

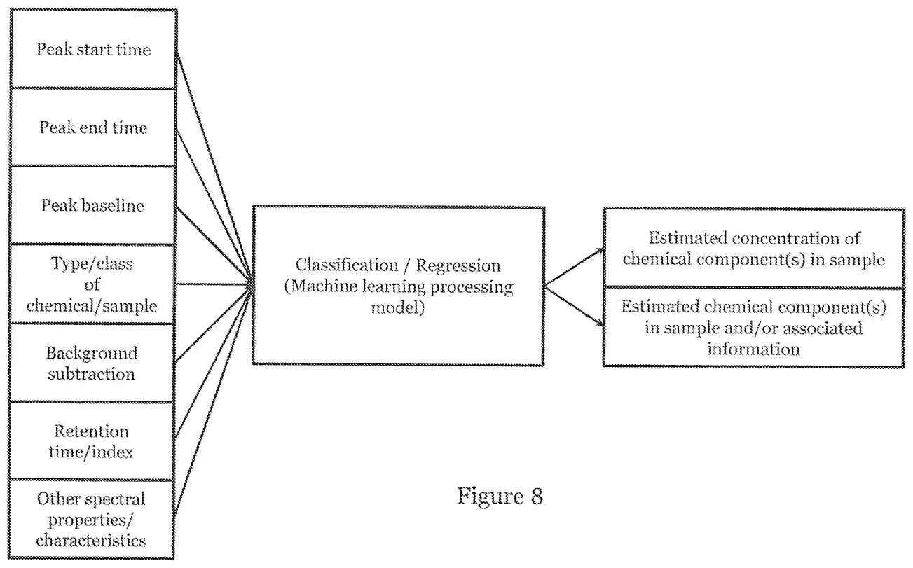

FIG. 8 is an example use of a machine learning controller (e.g., any one in FIGS. 1 to 6, 12A, 12B) in one embodiment of the invention. In this embodiment, the machine learning controller, with a machine learning processing model, is arranged to estimate at least one of: one or more or all (each) chemical component(s) in the chemical sample and/or associated information; concentration of one or more or all (each) chemical component(s) in chemical sample. The machine learning controller is arranged to receive one or more of the following associated with the spectral data as input: peak start time, peak end time, peak baseline, type/class of chemical/sample, background subtraction required, retention time/index, and other spectral properties/characteristics. The machine learning processing model is adapted to perform classification or regression (using different machine learning models as presented herein) based on the received one or more input to determine the output.

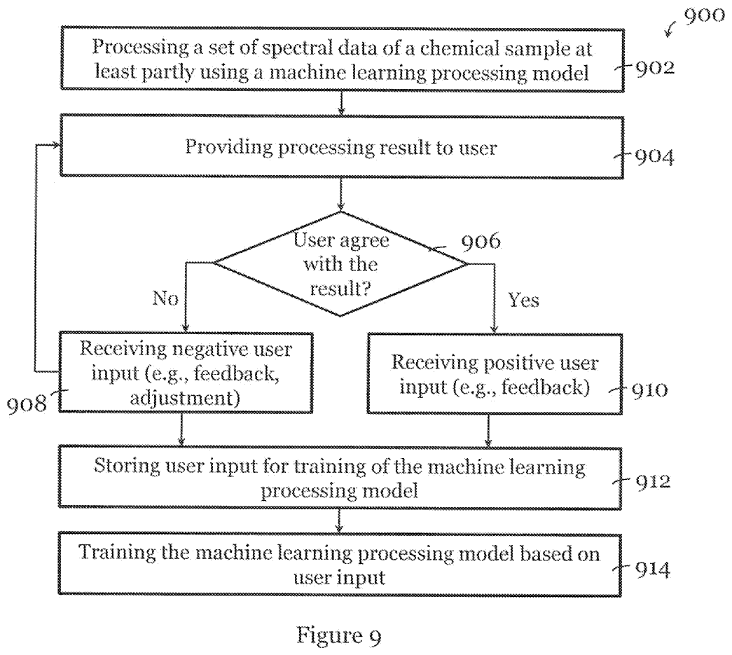

FIGS. 9 to 11 show exemplary methods for operating a spectral data processing system, such as but not limited to those (e.g., with machine learning controller) of any of FIGS. 1 to 6. It should be noted that the methods are exemplary and can be re-ordered otherwise adjusted as long as the modification is logical.

The method 900 in FIG. 9 mainly concerns the obtaining and using of the user input associated with processing of spectral data of a chemical sample. The method begins in step 902, in which a set of spectral data of a chemical sample is at least partly processed using a machine learning processing model. The processing of the spectral data can be entirely based on the machine learning processing model, or alternatively, partly based on the machine learning processing model and partly based on one or more of: other machine learning processing models or non-machine-learning processing, as presented herein (e.g., with respect to FIGS. 6-8). As another example, the processing may include performing at least one of the following using the machine learning processing model: spectral signal segmentation; spectral peak detection; spectral peak deconvolution; and chemical component related information determination. The chemical component related information determination may be performed based on the spectral signal segmentation, spectral peak detection, and/or the spectral peak deconvolution. The chemical component related information determination may determine only one, only some, or all chemical components in the chemical sample, and may include one or more of: chemical component class identification; chemical component type identification; chemical component identification; and chemical component concentration determination.

Then, in step 904, the processing result is provided to the user, e.g., via an output device such as a display. The processing result may be presented as a graphical representation (a plot, a spectrum, a table, a heat-map, or the like) of at least part of the spectral data or information associated with one or some or all chemical component(s) contained in the chemical sample, such as identity of the chemical component (s) and/or concentration of each of the chemical component(s). The user then reviews the data and the result, and in step 906, determines whether he/she agrees with the result or otherwise finds that the results are acceptable.

If the user agrees with the result, then he/she is required or can provide a positive user input, which is then received by the spectral data processing system via an input device in step 910. The machine learning processing model will be trained based on the received user input (representing a positive feedback). In one example, this involves training the machine learning processing model based on the spectral data and the processing result (associated with the user input representing positive feedback). In one example, data associated with the received user input (representing a positive feedback) is retained, weighted, or otherwise used in subsequent training of the machine learning processing model.

If the user disagrees with the result, then he/she is required or can provide a negative user input, which is then received by the spectral data processing system via an input device in step 908. Depending on the negative user input, the method may return to step 904 to re-process the data, especially when the spectral data is adjusted by the user (associated with the negative user input). In one example, the user input is associated with an adjustment on the spectral data and/or an adjustment on the processing result and including, e.g., one or more of the following: an adjusted peak start time; an adjusted peak end time; an adjusted peak baseline; an adjusted background subtraction; an adjusted retention time; an adjusted identity of a chemical component in the chemical sample; and an adjusted concentration of a chemical component in the chemical sample. In one example in which the user input (representing a negative feedback) is associated with an adjustment on the spectral data, the method further includes processing the adjusted spectral data at least partly using the machine learning processing model to determine an updated processing result. The adjusted spectral data, spectral data, and/or updated processing result can be used to train the machine learning processing model. In another example, the user input representing a negative feedback may simply be a reject command or information by the user, in which case the spectral data and/or processing result can be removed from the training set or can be given a reduced weighting in subsequent training.

After receiving the user input (positive or negative), in step 912, the user input, in particular the associated data and information, is stored for use in training of the machine learning processing model.

In step 914, the machine learning processing model is trained based on the received user inputs (in particular the associated data and information). The training may be performed continuously (e.g., every time a user input is received), periodically at regular or predetermined time intervals (every 1 hour, every day, etc.), after a predetermined number of user inputs have been received, on demand (e.g., upon user request), etc.

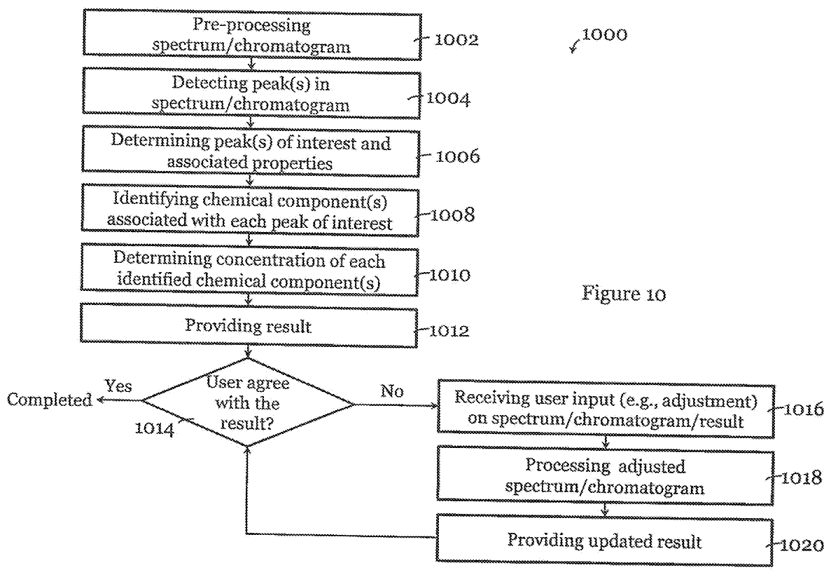

The method 1000 in FIG. 10 mainly concerns the processing of spectral data of a chemical sample. In step 1002, the spectral data, e.g., the spectrum or chromatogram, is preprocessed. The pre-processing may include non-machine-learning-based processing such as segmenting, thresholding, averaging, smoothing, padding, transforming, scaling, etc., as needed depending on application. Then the pre-processed spectral data is processed e.g., at least partly using a machine learning based processing method/machine learning processing model, to detect peak(s) in the pre-processed spectrum or chromatogram in step 1004, to determine peak(s) of interest and associated properties in step 1006, to identity chemical component(s) associated with each peak of interest in step 1008, and to determine concentration of each identified chemical component(s) in step 1010. One or more of steps 1004-1010 can be performed at substantially the same time, optionally using different machine learning processing models or the same machine learning processing model. In step 1006, the determination of the peak of interest may be based on a predetermined criteria set by the user. In one example, the user may specify the area of interest in the spectrum such that other areas of the spectrum are not processed (or if processed not presented to the user). In step 1012, the processing result is provided to the user, e.g., via an output device such as display. The processing result may be presented as a graphical representation (a plot, a spectrum, a table, a heat-map, or the like) of at least part of the spectral data or information associated with one or some or all chemical component(s) contained in the chemical sample, such as identity of the chemical component (s) and/or concentration of each of the chemical component(s). The user then reviews the data and the result, and in step 1014, determines whether he/she agrees with the result or otherwise finds that the results are acceptable.

If the user agrees with the result or otherwise finds that the results are acceptable, the method completes. If the user disagrees with the with the result or otherwise finds that the results are not acceptable, he/she may provide input to adjust the spectrum, the chromatogram, the processing result, or any other settings. If the user input (e.g., adjustments on spectrum or chromatogram or any other settings/data/information that affect the processing result) is received, then in step 1018, processing is performed using the updated data at least partly using the machine learning based processing method/machine learning processing model. This may involve repeating one or more of steps 1002 to 1010 on the updated data. After step 1018, the updated processing result is provided to the user in step 1020, in which case the user can review the data and the result, and return to step 1014, to determine whether he/she agrees with the result or otherwise finds that the results are acceptable. If the user now finds the result acceptable, then the method completes, otherwise the user may further adjust the spectrum, the chromatogram, the processing result, or any other settings, and repeat steps 1016 to 1020.

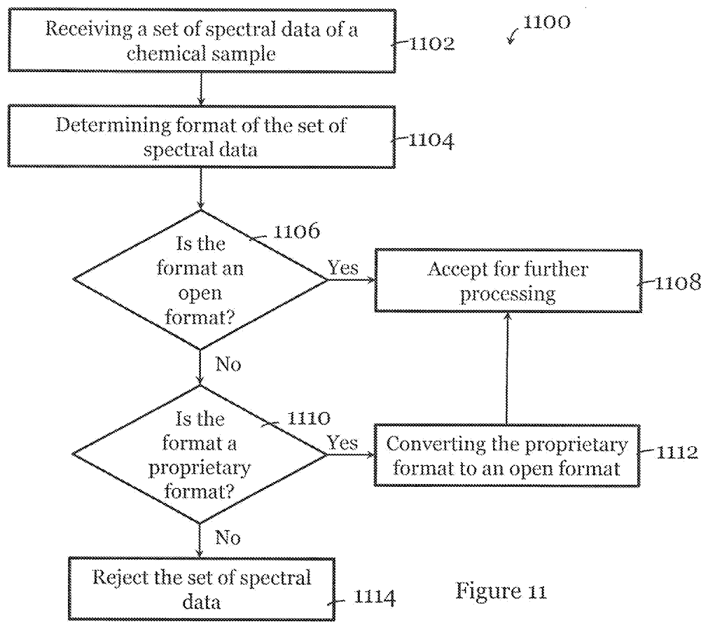

The method 1100 in FIG. 11 mainly concerns format conversion of spectral data prior to processing. The method 1100 begins in step 1102, in which a set of spectral data of a chemical sample is received by the system. Then, in step 1104, the system determines whether the format of the received spectral data. The determination may be made based on the metadata of the file of the spectral data, or specified, e.g., by the user who provides the data. In step 1106, a determination is made as to whether the format of the received spectral data is a default-accepted (e.g., open) format, which the system accepts. If the format is determined as an open format, then the method proceeds to step 1108, in which the received spectral data is accepted for further processing. If the format is determined as not an open format, then the method proceeds to step 1110, to determine whether it is a proprietary format. If, in step 1110, the format is determined to be a proprietary format, the system then converts the proprietary format into a default-accepted (e.g., open) format in step 1112, and then to step 1108 to accept the converted data. If in step 1110, the format is determined to be not a proprietary format, the data is rejected in step 1114 and will not be processed by the system. This happens when the format of the spectral data is neither a default-accepted (e.g., open) format nor a recognizable and/or convertible format.

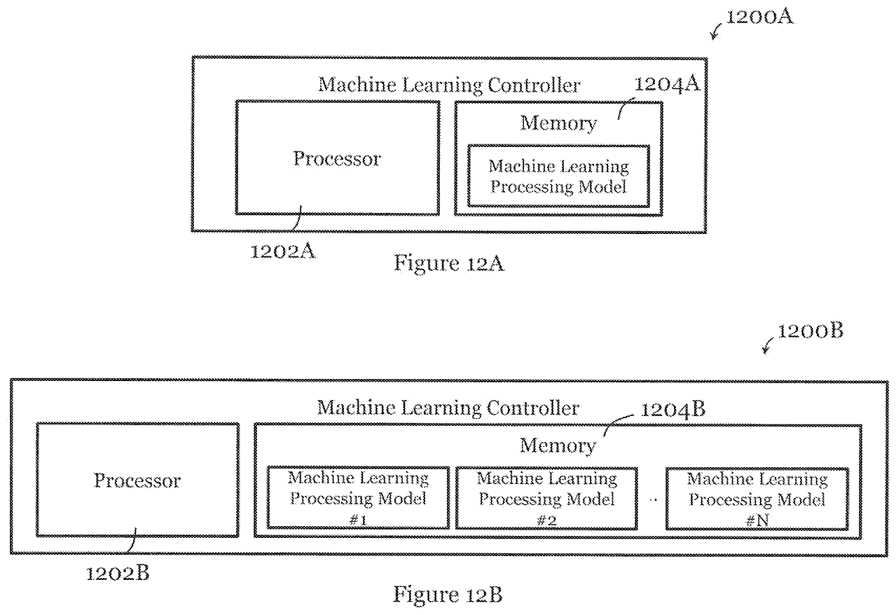

FIGS. 12A and 12B show exemplary machine learning controllers 1200A, 1200B in two embodiments of the invention. The machine learning controllers 1200A, 1200B can be used as the machine learning controllers as presented herein (e.g., in any of FIGS. 1 to 6). The machine learning controller 1200A includes a processor 1020A and a memory 1204A storing a machine learning processing model; the machine learning controller 1200A includes a processor 1020A and a memory 1204A storing multiple machine learning processing models each adapted for a specific task. The processor 1202A, 1202B may be formed by one or more of: CPU, MCU, controllers, logic circuits, Raspberry Pi chip, digital signal processor (DSP), application-specific integrated circuit (ASIC), Field-Programmable Gate Array (FPGA), or any other digital or analog circuitry configured to interpret and/or to execute program instructions and/or to process information and/or data. The memory 1204A, 1204B may include one or more volatile memory unit (such as RAM, DRAM, SRAM), one or more non-volatile memory unit (such as ROM, PROM, EPROM, EEPROM, FRAM, MRAM, FLASH, SSD, NAND, and NVDIMM), or any of their combinations.

The machine learning controller 1200A, 1200B is configured to initialize, construct, train, and/or operate one or more machine learning processing models (e.g., algorithms). In this embodiment, the machine learning processing model(s) can be initialized, constructed, trained, and/or operated based on supervised learning. The machine learning controller 1200A, 1200B can be presented with example input-output pairs, e.g., formed by example inputs and their actual outputs, to learn a general rule or model that maps the inputs to the outputs based on the provided example input-output pairs. Different machine learning processing model(s) can be trained differently, using different machine learning methods, input data, output data, etc., to suit specific task.

The machine learning controller may be configured to perform machine learning using various machine learning methods. For example, the machine learning controller may implement the machine learning program using different machine learning based models, recurrent models or non-recurrent models. These may include, e.g., recurrent neural network, long-short term memory model, Markov process, reinforcement learning, gated recurrent unit model, deep neural network, convolutional neural network (e.g., Unet), support vector machines, principle component analysis, logistic regression, decision trees/forest, ensemble method (combining model), regression (Bayesian/polynomial/regression), stochastic gradient descent, linear discriminant analysis, nearest neighbor classification or regression, naive Bayes, etc.

Each machine learning processing model can be trained to perform a particular spectral processing or classification task. For example, the machine learning controller can be trained to identify, based on input spectral data, an estimated chemical component(s) and/or associated information in the chemical sample associated with the spectral data; estimated concentration of chemical component(s) in the chemical sample associated with the spectral data; etc. As another example, the machine learning controller can be trained to identify, based on input spectral data, peak deconvolution, peak in the data, background subtraction required prior to estimating chemical component(s) and/or associated information or concentration. The task for which the respective machine learning processing model is trained may vary based on, for example, the class or type of chemical/sample, a user selection, user input, user (individual/company) account, type or class or model or location of the chemical analysis systems, the related application, and the like. The training of different machine learning processing models can be different. For example, the training examples/data used to train the machine learning processing models may include different information and may have different dimensions based on the task to be performed by the machine learning processing models.

Generally, training examples are provided to the machine learning controller and the machine learning controller uses them to generate or train a model (e.g., a rule, a set of equations, and the like), i.e., a machine learning processing model, that helps categorize or estimate an output based on new input data. The machine learning controller may weigh different training examples differently to, for example, prioritize different conditions or outputs. For example, the user input and the associated data or information as provided by the user of the spectral data processing system may be weighted more heavily. In one example, if the processing of the spectral data produces a result that the user finds satisfactory, as indicated by the user input, then such input spectral data and output result may be weighted more in subsequent training of the corresponding machine learning processing model. if the processing of the spectral data produces a result that the user finds unsatisfactory, as indicated by the user input, then such spectral data and/or output result as adjusted by the user may be stored and used subsequent training of the corresponding machine learning processing model. Optionally, the input spectral data and output result that leads to user dissatisfaction will be discarded or given less weight in subsequent training of the corresponding model.

In one embodiment an artificial neural network is implemented by the machine learning controller. The artificial neural network typically includes an input layer multiple hidden layers or nodes, and an output layer, operably connected with one another. The number of inputs may vary based on the particular task. Accordingly, the input layer of the artificial neural network of the machine learning controller (or of different models) may have a different number of nodes based on the particular task for the machine learning controller. The number of hidden layers varies and may depend on the particular task for the machine learning controller/model. Each hidden layer may have a different number of nodes and may be connected to the adjacent layer in a different manner. For example, each node of the input layer may be connected to each node of the first hidden layer, and the connections may each be assigned a respective weight parameter. In one example, each node of the neural network may also be assigned a bias value. The nodes of the first hidden layer may not be connected to each node of the second hidden layer, and again, the connections are each assigned a respective weight parameter. Each node of the hidden layer may be associated with an activation function that defines how the hidden layer is to process the input received from the input layer or from a previous hidden layer (upstream). These activation functions may vary. Each hidden layer may perform a different function. For example, some hidden layers can be convolutional hidden layers for reducing the dimensionality of the inputs, while other hidden layers can perform more statistical functions such as averaging, max pooling, etc. The last hidden layer is connected to the output layer, which usually has the same number of nodes as possible outputs. During training, the artificial neural network receives the inputs for a training example and generates an output using the bias for each node, and the connections between each node and the corresponding weights. The artificial neural network then compares the generated output with the actual output of the training example. Based on the generated output and the actual output of the training example, the neural network changes the weights associated with each node connection. In some embodiments, the neural network also changes the weights associated with each node during training. The training continues until, for example, a predetermined number of training examples being used, a accuracy threshold being reached during training and validation, a predetermined number of validation iterations being completed, etc. Different types of training algorithms, such as those listed above, can be used to adjust the bias values and the weights of the node connections based on the training examples.

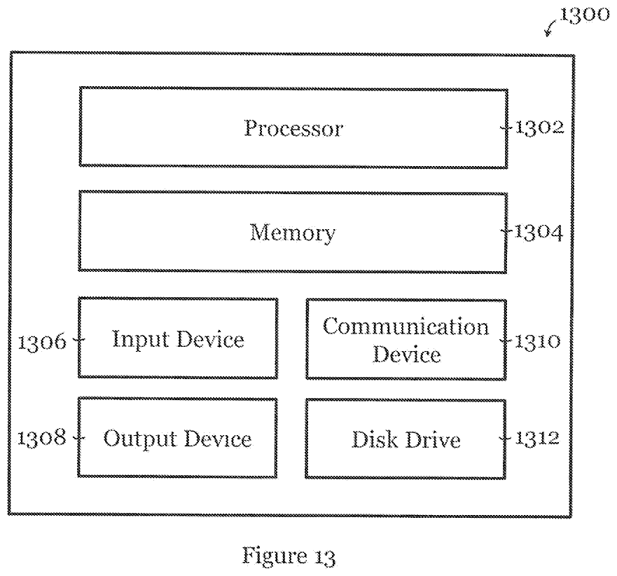

FIG. 13 shows an exemplary information handling system 1300 in one embodiment of the invention that can be used as a server or other information processing system, such as but not limited to one or more or all of the spectral data processing systems (with or without machine learning controllers, remote or associated with chemical analysis systems) and the servers, as in any of FIGS. 1 to 6. The information handling system 1300 may have different configurations, and it generally comprises suitable components necessary to receive, store, and execute appropriate computer instructions, commands, or codes. The main components of the information handling system 1300 are a processor 1302 and a memory 1304. The processor 1302 may be formed by one or more of: CPU, MCU, controllers, logic circuits, Raspberry Pi chip, digital signal processor (DSP), application-specific integrated circuit (ASIC), Field-Programmable Gate Array (FPGA), or any other digital or analog circuitry configured to interpret and/or to execute program instructions and/or to process information and/or data. The memory 1304 may include one or more volatile memory unit (such as RAM, DRAM, SRAM), one or more non-volatile memory unit (such as ROM, PROM, EPROM, EEPROM, FRAM, MRAM, FLASH, SSD, NAND, and NVDIMM), or any of their combinations. Optionally, the information handling system 1300 further includes one or more input devices 1306 such as a keyboard, a mouse, a stylus, an image scanner, a microphone, a tactile input device (e.g., touch sensitive screen), and an image/video input device (e.g., camera). Optionally, the information handling system 1300 further includes one or more output devices 1308 such as one or more displays (e.g., monitor), speakers, disk drives, headphones, earphones, printers, 3D printers, etc. The display may include a LCD display, a LED/OLED display, or any other suitable display that may or may not be touch sensitive. The information handling system 1300 may further include one or more disk drives 1312 which may encompass solid state drives, hard disk drives, optical drives, flash drives, and/or magnetic tape drives. A suitable operating system may be installed in the information handling system 1300, e.g., on the disk drive 1312 or in the memory 1304. The memory 1304 and the disk drive 1312 may be operated by the processor 1302. Optionally, the information handling system 1300 also includes a communication device 1310 for establishing one or more communication links (not shown) with one or more other computing devices such as servers, personal computers, terminals, tablets, phones, or other wireless or handheld computing devices. The communication device 1310 may be a modem, a Network Interface Card (NIC), an integrated network interface, a radio frequency transceiver, an optical port, an infrared port, a USB connection, or other wired or wireless communication interfaces. The communication links may be wired or wireless for communicating commands, instructions, information and/or data. In one example, the processor 1302, the memory 1304, and optionally the input device(s) 1306, the output device(s) 1308, the communication device 1310 and the disk drives 1312 are connected with each other through a bus, a Peripheral Component Interconnect (PCI) such as PCI Express, a Universal Serial Bus (USB), an optical bus, or other like bus structure. In one embodiment, some of these components may be connected through a network such as the Internet or a cloud computing network. A person skilled in the art would appreciate that the information handling system 1300 shown in FIG. 13 is merely exemplary and different information handling systems 1300 with different configurations may be applicable in the embodiments of the invention.

Advantageously, the invention provides a spectral data processing system that learns from different users (e.g., chemists, scientists, researchers) on how the spectral data should be processed and uses the learned knowledge to process spectral data. The system can take feedback from one or more users, e.g., from the same user over time, from different users at the same or different geographical locations, etc., optionally based on the properties of the materials to which the spectral data relate. The system can generally improve its spectral data processing efficiency, speed, and/or accuracy over time based on user feedback. In some implementations, the system enables or facilitates collaboration of different users (e.g., chemists, scientists, researchers), regardless of the type, model, configuration, manufacturer, and/or operation condition of the spectrometer that is used to obtain the spectral data.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system” and “computing device” are used, these terms are intended to include any appropriate arrangement of computer or information processing hardware capable of implementing the function described.

In one implementation, the spectral data processing system(s) and/or the machine learning controller(s) are arranged on one or more cloud computing networks. In another implementation, the spectral data processing system(s) and/or the machine learning controller(s) are arranged on one or more edge computing networks (edge networks). In yet another implementation, the spectral data processing system(s) and/or the machine learning controller(s) are arranged on one or more private networks arranged on edge application. Other non-cloud or non-edge-based networks can be used in some other embodiments. The choice of networks can be based on security requirement or specific applications.

It will be appreciated by persons skilled in the art that numerous variations and/or modifications may be made to the invention as shown in the specific embodiments without departing from the scope of the invention as broadly described and claimed. Each embodiment may include additional or fewer functional or structural features as described. Features in different embodiments may be selectively combined, grouped, re-grouped, etc., to provide new embodiments, as long as the resulting combination is logical and feasible.

In one implementation the above embodiments, the invention can be used to that identify peaks by retention index and mass spectrum and determine concentration based on peaks deconvolution and baseline prediction. The spectral data analysis, by using machine learning for peak deconvolution, etc., by using neural network and algorithmic approaches with learning capabilities to process spectral data, and/or by learning from user interaction, can become more accurate and ‘intelligent’ over time on various tasks, including but not limited to, peak detection (start/end time=baseline, background subtraction before mass spectrum comparison to identify chemical component(s) in sample, and confirmation of substance by mass spectrum.

The described embodiments of the invention should therefore be considered in all respects as illustrative, not restrictive. The chemical analysis system may be any system arranged to produce spectral data of a chemical sample, including: a gas chromatograph, a liquid chromatograph, a mass spectrometer, such as a gas chromatography-mass spectrometer or a liquid chromatography-mass spectrometer. The spectral data can be data of a chromatogram or a mass spectrum. In one specific application the chemical sample may include phthalate and a machine learning processing model may be specifically adapted for processing spectral data associated with phthalate.

1. A method for operating a spectral data processing system, comprising:
receiving a user input associated with processing of spectral data of a chemical sample at least partly using a machine learning processing model, the machine learning processing model being arranged in a machine learning controller of the spectral data processing system; and
storing the received user input for training the machine learning processing model based on the received user input.

2. The method of claim 1, further comprising: training the machine learning processing model based on the received user input.

3. The method of claim 1, further comprising, prior to receiving the user input:
processing the spectral data at least partly using the machine learning processing model to provide a processing result, wherein the processing includes performing one or more of the following using the machine learning processing model:
spectral signal segmentation;
spectral peak detection;
spectral peak deconvolution; and
chemical component related information determination.

4. The method of claim 3, wherein the chemical component related information determination is performed based on the spectral signal segmentation, spectral peak detection, and/or the spectral peak deconvolution.

5. The method of claim 3, wherein the chemical component related information determination includes one or more of:
chemical component class identification;
chemical component type identification;
chemical component identification; and
chemical component concentration determination.

6. The method of claim 1, further comprising, prior to receiving the user input:
providing a processing result of the processing of the spectral data, wherein providing the processing result includes providing at least one of:
a graphical representation of at least part of the spectral data; and
information associated with at least one chemical component contained in the chemical sample.

7. The method of claim 6, wherein information associated with the at least one chemical component includes:
identity of the least one chemical component and/or concentration of each of the at least one chemical component.

8. The method of claim 3, further comprising, prior to the processing:
selecting the machine learning processing model from a plurality of machine learning processing models arranged in the machine learning controller,
wherein each respective one of the plurality of machine learning processing models is associated with a respective type or class of chemical sample, and the selection is based on a type or class of the chemical sample.

9. The method of claim 3, wherein the user input represents a positive feedback on the processing result.

10. The method of claim 9, further comprising training of the machine learning processing model based on the received user input, which comprises:
training the machine learning processing model based on the spectral data and the processing result.

11. The method of claim 3, wherein the user input represents a negative feedback on the processing result.

12. The method of claim 11, wherein the user input is associated with an adjustment on the spectral data and/or an adjustment on the processing result, wherein the user input includes one or more of the following:
an adjusted peak start time;
an adjusted peak end time;
an adjusted peak baseline;
an adjusted background subtraction;
an adjusted retention time;
an adjusted identity of a chemical component in the chemical sample; and
an adjusted concentration of a chemical component in the chemical sample.

13. The method of claim 11, wherein the user input is associated with an adjustment on the spectral data, and
the method further comprises:
processing the adjusted spectral data at least partly using the machine learning processing model to determine an updated processing result; and
wherein the training of the machine learning processing model based on the received user input comprises:
training the machine learning processing model based on the adjusted spectral data and the updated processing result.

14. The method of claim 1, wherein the machine learning processing model includes an artificial neural network.

15. The method of claim 3, further comprising, prior to the processing:
determining a format of the spectral data; and
if it is determined that the format of the spectral data is a proprietary format, converting the format of the spectral data from the proprietary format to an open format.

16. The method of claim 1, further comprising:
receiving one or more further user inputs, each associated with a respective processing of a respective spectral data of a respective chemical sample using the machine learning processing model;
storing the one or more received further user inputs for training the machine learning processing model based on the one or more received further user inputs;
training the machine learning processing model based on the one or more received further user inputs;
wherein training the machine learning processing model comprises:
training the machine learning processing model periodically; or
training the machine learning processing model after a predetermined number of user inputs have been received.

17. The method of claim 1, wherein the spectral data is data of a chromatogram or a mass spectrum, and wherein the spectral data processing system is associated with a chemical analysis system.

18. The method of claim 17,
wherein the chemical analysis system comprises a gas chromatograph or a liquid chromatograph, and the spectral data comprises data of a chromatogram of a chemical sample; or
wherein the chemical analysis system comprises a mass spectrometer, and the spectral data comprises data of a mass spectrum of a chemical sample.

19. A spectral data processing system, comprising:
one or more processors arranged to:
receive a user input associated with processing of spectral data of a chemical sample at least partly using a machine learning processing model; and
train the machine learning processing model based on the received user input.

20. The spectral data processing system of claim 19, further comprising a machine learning controller with the machine learning processing model; the machine learning controller including the one or more processors.

21. The spectral data processing system of claim 19, wherein the one or more processors are further arranged to:
process the spectral data at least partly using the machine learning processing model to provide a processing result
wherein the one or more processors are further arranged to perform one or more of the following using the machine learning processing model:
spectral signal segmentation;
spectral peak detection;
spectral peak deconvolution; and
chemical component related information determination,
wherein the chemical component related information determination includes one or more of:
chemical component class identification;
chemical component type identification;
chemical component identification; and
chemical component concentration determination.

22. The spectral data processing system of claim 19, further comprising an output device arranged to provide a processing result of the processing of the spectral data.

23. The spectral data processing system of claim 20, wherein the one or more processors are further arranged to:
select or receive selection of the machine learning processing model from a plurality of machine learning processing models arranged in the machine learning controller;
wherein each respective one of the plurality of machine learning processing models is associated with a respective type or class of chemical sample, and the selection is based on a type or class of the chemical sample.

24. The spectral data processing system of claim 21, wherein the user input represents a positive feedback on the processing result, and wherein the one or more processors are arranged to train the machine learning processing model based on the received user input by, at least, training the machine learning processing model based on the spectral data and the processing result.

25. The spectral data processing system of claim 21, wherein the user input represents a negative feedback on the processing result, and wherein the user input is associated with an adjustment on the spectral data and/or an adjustment on the processing result.

26. The spectral data processing system of claim 25, wherein the user input includes one or more of the following:
an adjusted peak start time;
an adjusted peak end time;
an adjusted peak baseline;
an adjusted background subtraction;
an adjusted retention time;
an adjusted identity of a chemical component in the chemical sample; and
an adjusted concentration of the chemical component in the chemical sample.

27. The spectral data processing system of claim 25, wherein the user input is associated with an adjustment on the spectral data, and
wherein the one or more processors are arranged to:
process the adjusted spectral data at least partly using the machine learning processing model to determine an updated processing result.

28. The spectral data processing system of claim 27, wherein the one or more processors are arranged to train the machine learning processing model based on the received user input by, at least, training the machine learning processing model based on the adjusted spectral data and the updated processing result.

29. The spectral data processing system of claim 19, wherein the machine learning processing model includes an artificial neural network.

30. The spectral data processing system of claim 21, wherein the one or more processors are arranged to:
determine a format of the spectral data;
convert the format of the spectral data from a proprietary format to an open format, if it is determined that the format of the spectral data is a proprietary format;
receive one or more further user inputs, each associated with a respective processing of a respective spectral data of a respective chemical sample using the machine learning processing model; and
train the machine learning processing model based on the one or more received further user inputs.

31. The spectral data processing system of claim 30, wherein the one or more processors are arranged to train the machine learning processing model periodically; or wherein the one or more processors are arranged to train the machine learning processing model after a predetermined number of user inputs have been received.

32. The spectral data processing system of claim 19, wherein the spectral data is data of a chromatogram or a mass spectrum; or wherein the spectral data processing system is associated with a chemical analysis system.

33. The spectral data processing system of claim 32, wherein the chemical analysis system comprises a gas chromatograph or a liquid chromatograph, and the spectral data comprises data of a chromatogram of a chemical sample; or wherein the chemical analysis system comprises a mass spectrometer, and the spectral data comprises data of a mass spectrum of a chemical sample, wherein the mass spectrometer is a gas chromatography-mass spectrometer or a liquid chromatography-mass spectrometer.
